(19) United States
(12) Patent Application Publication
(10) Pub. No.: US 2015/0002575 A1
(43) Pub. Date: Jan. 1, 2015

(54) INK HAVING ANTIBACTERIAL AND ANTIFUNGAL PROTECTION

(71) Applicants: Thomas Nelson Blanton, Newton Square, PA (US); Valerie Lynn Kuykendall, Penfield, PA (US); John Joseph Scheible, Fairport, NY (US); Greg Munro, Abderdeen (GB); Tomas Gerard Patrick McHugh, Webster, NY (US); Linda Mae Franklin, Rochester, NY (US); Christine Joanne Landry-Coltrain, Fairport, NY (US)

(72) Inventors: Thomas Nelson Blanton, Newton Square, PA (US); Valerie Lynn Kuykendall, Penfield, PA (US); John Joseph Scheible, Fairport, NY (US); Greg Munro, Abderdeen (GB); Tomas Gerard Patrick McHugh, Webster, NY (US); Linda Mae Franklin, Rochester, NY (US); Christine Joanne Landry-Coltrain, Fairport, NY (US)

(21) Appl. No.: 13/928,427

(22) Filed: Jun. 27, 2013

(51) Int. Cl. C09D 11/38

(52) U.S. Cl. CPC C09D 11/38; C08K 3/30
USPC 347/20; 106/15.05; 523/122; 106/18.32

(57) ABSTRACT

Ink for use in a printer for forming coating or a colored ink on a substrate is disclosed. The coating or colored image provides antibacterial and antifungal protection. The inks include a mixture of solvent and a silver sulfate biocide having a concentration range of 0.0005 to 0.5 weight %.

### CROSS REFERENCE TO RELATED APPLICATIONS

Reference is made to commonly assigned U.S. patent application Ser. No. 13/235,789 filed Sep. 19, 2011 entitled “Antibacterial and Antifungal Protection for Toner Image” by Thomas N. Blanton et al, U.S. patent application Ser. No. 13/357,060 filed Jan. 24, 2012 entitled “Antibacterial and Antifungal Protection For Ink Jet Image” by Thomas N. Blanton et al, and U.S. patent application Ser. No. 13/357,060 filed Jan. 24, 2012 entitled “Ink Having Antibacterial And Antifungal Protection” by Thomas N. Blanton et al, the disclosures of which are incorporated herein.

### FIELD OF THE INVENTION

The present invention relates to inks which can form clear coatings or colored images and have antimicrobial efficacy.

### BACKGROUND OF THE INVENTION

Ink jet printing is a non-impact method for producing images by the deposition of ink droplets in a pixel-by-pixel manner to an image-recording element in response to digital signals. There are various methods which can be used to control the deposition of ink droplets on the image-recording element to yield the desired image. In one process, known as continuous ink jet, a continuous stream of droplets is charged and deflected in an imagewise manner onto the surface of the image-recording element, while unimaged droplets are caught and returned to an ink sump. In another process, known as drop-on-demand ink jet, individual ink droplets are projected as needed onto the image-recording element to form the desired image. Common methods of controlling the projection of ink droplets in drop-on-demand printing include piezoelectric transducers and thermal bubble formation Ink jet printers have found broad applications across markets ranging from industrial labeling to short run printing to desktop document and pictorial imaging.

Flexography is another method of printing or pattern formation that is commonly used for high-volume printing runs. It is usually employed for printing on a variety of soft or easily deformed materials including but not limited to, paper, paperboard stock, corrugated board, polymeric films, fabrics, and metal foils, and also including more rigid materials such as glass, glass-coated materials, flexible glass materials, and laminates of multiple materials. Coarse surfaces and stretchable polymeric films are economically printed using flexography.

In order to accommodate the various types of substrates, flexographic printing plates (printing members) generally have a rubbery or elastomeric nature whose precise properties are adjusted for a particular substrate and printed surface.

Flexographic printing members are sometimes known as “relief” printing members (for example, relief-containing printing plates, printing sleeves, or printing cylinders) and are provided with raised relief images onto which ink is applied for application to a printable material. While the raised relief images are inked, the relief “floor” and “walls” should remain free of ink.

Gravure or intaglio printing is also performed using printing members that are also relief printing members in which the image to be printed comprises depressions or recesses on the surface of the printing member, where the printing area is localized to the areas of depression that define the pattern or image. The process for using gravure or intaglio printing members is the reverse of flexographic relief printing wherein an image is raised above the floor of the flexographic printing member and the printing area is localized at the contact area of the top surface protrusions.

The inks used in the various ink jet printers can be classified as either dye-based or pigment-based. A dye is a colorant which is molecularly dispersed or solvated by a carrier medium. A pigment is a colorant that is insoluble in the carrier medium, but is dispersed or suspended in the form of small particles, often stabilized against flocculations and settling by the use of dispersing agents. The carrier medium can be a liquid or a solid at room temperature. A commonly used carrier medium is water or a mixture of water and organic co-solvents. In dye-based inks, no particles are observable under the microscope; in pigment-based inks particles are observable under the microscope.

The inks used in various flexographic and gravure printers can be classified as aqueous-based, solvent-based, or UV (ultraviolet) curable inks. These are typically designed and formulated to provide appropriate viscosity for printing, adhesion to the substrate, color, and functional properties. Typically, pigments or carbon black are incorporated to provide color. The viscosities of flexographic and gravure inks are generally higher than those used for inkjet printing, and range from about 10 to 5,000 cps (mPa·s). The viscosity of flexo ink must be low enough to transfer properly to the inking system, but not run off the plate or during the printing. Aqueous and solvent based inks dry by evaporation during the printing.

An ink jet recording element typically includes a support having on at least one surface thereof an ink-receiving or image-forming layer and includes those intended for reflection viewing, which have an opaque support, and those intended for viewing by transmitted light, which have a transparent support. The ink-receiving layer can be a polymer layer which swells to absorb the ink or a porous layer which imbibes the ink via capillary action.

A flexographic recording element typically includes a variety of soft or easily deformed materials including but not limited to, paper, paperboard stock, corrugated board, polymeric films, fabrics, and metal foils, and also including more rigid materials such as glass, glass-coated materials, flexible glass materials, and laminates of multiple materials. Coarse surfaces and stretchable polymeric films are economically printed using flexography.

Widespread attention has been focused in recent years on the consequences of bacterial and fungal contamination contracted by contact with common surfaces and objects. Some noteworthy examples include the sometimes fatal outcome from food poisoning due to the presence of particular strains of Escherichia coli in undercooked beef; Salmonella contamination in undercooked and unwashed poultry food products; as well as illnesses and skin irritations due to Staphylococcus aureus and other micro-organisms. Anthrax is an acute infectious disease caused by the spore-forming bacterium bacillus anthracis. Allergic reactions to molds and yeasts are a major concern to many consumers and insurance companies alike. In addition, significant fear has arisen in regard to the development of antibiotic-resistant strains of bacteria, such as methicillin-resistant Staphylococcus aureus (MRSA) and vancomycin-resistant Enterococcus (VRE). The Centers for Disease Control and Prevention estimates that 10% of patients contract additional diseases during their hospital stay and that the total deaths resulting from these nosocomially-contracted illnesses exceeds those suffered from vehicular traffic accidents and homicides. In response to these concerns, manufacturers have begun incorporating antimicrobial agents into materials used to produce objects for commercial, institutional and residential use.

Noble metal ions such as silver and gold ions are known for their antimicrobial properties and have been used in medical care for many years to prevent and treat infection. In recent years, this technology has been applied to consumer products to prevent the transmission of infectious disease and to kill harmful bacteria such as Staphylococcus aureus and Salmonella. In common practice, noble metals, metal ions, metal salts, or compounds containing metal ions having antimicrobial properties can be applied to surfaces to impart an antimicrobial property to the surface. If, or when, the surface is inoculated with harmful microbes, the antimicrobial metal ions or metal complexes, if present in effective concentrations, will slow or even prevent altogether the growth of those microbes. Recently, silver sulfate, Ag₂SO₄, described in U.S. Pat. No. 7,579,396, U.S. Patent Application Publication 20080242794, U.S. Patent Application Publication 20090291147, U.S. Patent Application Publication 20100093851, and U.S. Patent Application Publication 20100160486 has been shown to have efficacy in providing antimicrobial protection in polymer composites. The United States Environmental Protection Agency (EPA) evaluated silver sulfate as a biocide and registered its use as part of EPA Reg. No, 59441-8 EPA EST. NO. 59441-NY-001. In granting that registration, the EPA determined that silver sulfate was safe and effective in providing antibacterial and antifungal protection.

Antimicrobial activity is not limited to noble metals but is also observed in organic materials such as triclosan, and some polymeric materials.

It is important that the antimicrobial active element, molecule, or compound be present on the surface of the article at a concentration sufficient to inhibit microbial growth. This concentration, for a particular antimicrobial agent and bacterium, is often referred to as the minimum inhibitory concentration (MIC). It is also important that the antimicrobial agent be present on the surface of the article at a concentration significantly below that which can be harmful to the user of the article. This prevents harmful side effects of the article and decreases the risk to the user, while providing the benefit of reducing microbial contamination. There is a problem in that the rate of release of antimicrobial ions from antimicrobial films can be too facile, such that the antimicrobial article can quickly be depleted of antimicrobial active materials and become inert or non-functional. Depletion results from rapid diffusion of the active materials into the biological environment with which they are in contact, for example, water soluble biocides exposed to aqueous or humid environments. It is desirable that the rate of release of the antimicrobial ions or molecules be controlled such that the concentration of antimicrobials remains above the MIC. The concentration should remain there over the duration of use of the antimicrobial article. The desired rate of exchange of the antimicrobial can depend upon a number of factors including the identity of the antimicrobial metal ion, the specific microbe to be targeted, and the intended use and duration of use of the antimicrobial article.

The use of an organic biocide to prevent unwanted microbial growth which can occur in liquid ink jet inks over time is disclosed in U.S. Pat. No. 6,210,474, but does not demonstrate any antimicrobial efficacy in printed layers or printed images. U.S. Pat. No. 7,112,630 discloses the use of an antimicrobial active compound coupled to a branch of polyvinyl alcohol (PVA) to extend storage stability of liquid ink jet ink. However, the process for making the modified PVA requires a complex process that includes using dimethylsulfoxide as a solvent and further includes additional chemicals and required concentration levels not compatible with ink jet formulations described in this invention. U.S. Patent Application Publication 2011/0281089 describes an ink jet composition containing silver particles to produce prints with metallic gloss but have no antimicrobial efficacy. Sun Innovations describes inks with antibacterial effect but not antifungal effect. However these inks are not compatible for printing on paper sheets.

### SUMMARY OF THE INVENTION

Certain types of antimicrobial biocides can be effectively incorporated in ink jet inks or flexographic inks without having any consequential degradation of the ink jet or flexography layer or images for a viewer. It has unexpectedly been discovered that certain types of silver salts can be advantageously used in ink jet or flexographic inks as a biocide without degrading the ink jet or flexography layer or image. It has been found that silver sulfate is suitable for use in ink jet or flexographic inks in that it can be deposited onto a substrate or support and be able to be delivered to the substrate or support using an ink jet or flexographic printing device without processing issues.

It has been unexpectedly found that when silver sulfate is limited in the concentration of 0.0005 to 0.5 weight % highly effective images can be produced and the antimicrobial function of the silver sulfate is still quite effective.

The present invention recognizes that ink jet or flexography coatings and ink jet or flexography images on substrates including menus, letters, pictures, documents and the like can be a source of microorganisms such as bacteria or fungi via handling, nasal discharges, and contact with infected persons. Such microbe colonies can be destroyed or their growth inhibited if the print substrate is treated with an effective antimicrobial agent (ink jet or flexographic ink).

In accordance with the present invention there is provided an ink for use in a printer, comprising;

a solvent; and

a silver sulfate biocide having a concentration of 0.0005 to 0.5 weight %.

The present invention recognizes and demonstrates that silver sulfate can work in this application and is very effective in providing antibacterial and antifungal protection, is compatible with chemicals used to make ink jet and flexographic inks, and does not degrade the image when used in the range of 0.0005 weight % to 0.5 weight %. It has also been recognized that inks provided by the present invention do not interfere with the ink jet or flexographic printing process. It is further recognized that inks provided by the present invention are safe for contact by the users of the article.

### DETAILED DESCRIPTION OF THE INVENTION

Inks and ink compositions described in this invention are defined as being used in ink jet printing, or flexographic printing, or both. Ink compositions known in the art of ink jet or flexographic printing can be aqueous-based or organic solvent-based, and in a liquid, solid or gel state at room temperature and pressure. Aqueous-based ink compositions are preferred in the present invention because they are more environmentally friendly as compared to solvent-based inks, plus most ink jet printheads are designed for use with aqueous-based inks By aqueous inks is meant that the ink composition includes at least 50% and preferably at least 65% by weight water Inks used for flexographic or gravure printing can include amounts of water, solvent, or volatile compounds, up to and including about 70% by weight, or cannot included any volatile components at all, such as with UV-curable inks.

The ink composition can be colored with pigments, dyes, polymeric dyes, loaded-dye/latex particles, or any other types of colorants, or combinations thereof. Pigment-based ink compositions are preferred in the invention because such inks render printed images having higher optical densities, and better fade resistance to light and ozone exposure as compared to printed images made from other types of colorants. The ink composition can for example be yellow, magenta, cyan, black, gray, red, violet, blue, green, orange, or brown. The ink is colored by the dispersed pigment colorant. The inks of the invention can have one pigment colorant or mixtures of more than one pigment colorant.

A wide variety of organic and inorganic pigments, alone or in combination with additional pigments or dyes can be used in the ink composition of the present invention. Pigments that can be used in the invention include those disclosed in, for example, U.S. Pat. Nos. 5,026,427; 5,086,698; 5,141,556; 5,160,370; and 5,169,436. The exact choice of pigments will depend upon the specific application and performance requirements such as color reproduction and image stability.

Pigments suitable for use in the invention include, but are not limited to, azo pigments, monoazo pigments, di-azo pigments, azo pigment lakes, β-Naphthol pigments, Naphthol AS pigments, benzimidazolone pigments, di-azo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, or carbon black or combinations thereof.

Typical examples of pigments that can be used include Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C.I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66, bridged aluminum phthalocyanine pigments; C.I. Pigment Black 1, 7, 20, 31, 32; C. I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C.I. Pigment Green 1, 2, 4, 7, 8, 10, 36, 45; C.I. Pigment Violet 1, 2, 3, 5:1, 13, 19, 23, 25, 27, 29, 31, 32, 37, 39, 42, 44, 50; or C.I. Pigment Brown 1, 5, 22, 23, 25, 38, 41, 42.

The preferred pigment-based ink compositions employing surfactant dispersed pigments that are useful in the invention can be prepared by any known method. Useful methods commonly involve two steps: (a) a dispersing or milling step to break up the pigments to primary particles, where primary particle is defined as the smallest identifiable subdivision in a particulate system, and (b) a dilution step in which the pigment dispersion from step (a) is diluted with the remaining ink components to give a working strength ink.

The milling step (a) is carried out using any type of grinding mill such as a media mill, a ball mill, a two-roll mill, a three-roll mill, a bead mill, and air jet mill, an attritor, or a liquid interaction chamber. In the milling step (a), pigments are optionally suspended in a medium that is typically the same as or similar to the medium used to dilute the pigment dispersion in step (b). Inert milling media are optionally present in the milling step (a) in order to facilitate breakup of the pigments to primary particles. Inert milling media include such materials as polymeric beads, glasses, ceramics, metals and plastics as described, for example, in U.S. Pat. No. 5,891,231. Milling media are removed from either the pigment dispersion obtained in step (a) or from the ink composition obtained in step (b).

A dispersant, or pigment dispersant, is optionally present in the milling step (a) in order to facilitate breakup of the pigments into primary particles. For the pigment dispersion obtained in step (a) or the ink composition obtained in step (b), a dispersant is optionally present in order to maintain particle stability and prevent settling. Dispersants suitable for use in the invention include, but are not limited to, those commonly used in the art of ink jet printing. For aqueous pigment-based ink compositions, particularly useful dispersants include anionic, cationic or nonionic surfactants such as sodium dodecylsulfate, or potassium or sodium oleylmethyltaurate as described in, for example, U.S. Pat. Nos. 5,679,138; 5,651,813 or 5,985,017, the disclosures of which are incorporated by reference.

Self-dispersing pigments that are dispersible without the use of a dispersant or surfactant can be used in the invention. Pigments of this type are those that have been subjected to a surface treatment such as oxidation/reduction, acid/base treatment, or functionalization through coupling chemistry. The surface treatment can render the surface of the pigment with anionic, cationic or non-ionic groups such that a separate dispersant is not necessary. The preparation and use of covalently functionalized self-dispersed pigments suitable for ink jet printing are reported by Bergemann, et al., in U.S. Pat. No. 6,758,891 B2 and U.S. Pat. No. 6,660,075 B2, Belmont in U.S. Pat. No. 5,554,739, Adams and Belmont in U.S. Pat. No. 5,707,432, Johnson and Belmont in U.S. Pat. Nos. 5,803,959 and 5,922,118, Johnson et al in and U.S. Pat. No. 5,837,045, Yu et al in U.S. Pat. No. 6,494,943 B1, and in published applications WO 96/18695, WO 96/18696, WO 96/18689, WO 99/51690, WO 00/05313, and WO 01/51566, Osumi et al., in U.S. Pat. Nos. 6,280,513 B1 and 6,506,239 B1, Karl, et al., in U.S. Pat. No. 6,503,311 B1, Yeh, et al., in U.S. Pat. No. 6,852,156 B2, Ito et al., in U.S. Pat. No. 6,488,753 B1 and Momose et al., in EP 1,479,732 A1. Examples of commercially available self-dispersing type pigments include Cab-O-Jet 200®, Cab-O-Jet-250®, Cab-O-Jet-260®, Cab-O-Jet-270®, and Cab-O-Jet 300® (Cabot Specialty Chemicals, Inc.) and Bonjet CW-1@ and CW-2® (Orient Chemical Industries, Ltd.).

Encapsulating type polymeric dispersants and polymeric dispersed pigments thereof can also be used in the invention. Specific examples are described in U.S. Pat. No. 6,723,785, U.S. Pat. No. 6,852,777, U.S. Patent Application Publications 2004/0132942 A1, 2005/0020731 A1, 2005/00951 A1, 2005/0075416 A1, 2005/0124726 A1, 2004/007749 A1, and 2005/0124728 A1, the disclosures of which are incorporated by reference. Encapsulating type polymeric dispersants can be especially useful because of their high dispersion stability on keeping and low degree of interaction with ink components.

Composite colorant particles having a colorant phase and a polymer phase are also useful in aqueous pigment-based inks of the invention. Composite colorant particles are formed by polymerizing monomers in the presence of pigments; see for example, U.S. Pat. No. 7,479,183 and U.S. Patent Application Publications 2003/0203988 and 2004/0127639. Microencapsulated-type pigment particles are also useful and include pigment particles coated with a resin film; see for example U.S. Pat. No. 6,074,467.

The inks can further contain dyes. Dyes suitable for use in the invention include, but are not limited to, those commonly used in the art of ink jet or flexographic printing. For aqueous-based ink compositions, such dyes include water-soluble reactive dyes, direct dyes, anionic dyes, cationic dyes, acid dyes, food dyes, metal-complex dyes, phthalocyanine dyes, anthraquinone dyes, anthrapyridone dyes, azo dyes, rhodamine dyes, or solvent dyes or combinations thereof. Specific examples of dyes usable in the present invention include but are not limited to: Acid Yellows, Reactive Yellows, Food Yellows, Acid Reds, Direct Reds, Reactive Reds, Food Reds, Acid Blues, Direct Blues, Reactive Blues, Food Blues, Acid Blacks, Direct Blacks, Reactive Blacks, Food Black, CAS No. 224628-70-0 sold as JPD Magenta EK-1 Liquid from Nippon Kayaku Kabushiki Kaisha; CAS No. 153204-88-7 sold as Intrajet® Magenta KRP from Crompton and Knowles Colors; and the metal azo dyes disclosed in U.S. Pat. Nos. 5,997,622 and 6,001,161. Inks with dyes can further contain dye solubility agent.

Also useful in the invention are polymeric dyes or loaded-dye/latex particles. Examples of polymeric dyes are described in U.S. Pat. No. 6,457,822 B1 and references therein. Examples of loaded-dye/latex particles are described in U.S. Pat. Nos. 6,431,700; 6,867,251 and 7,317,042 and U.S. Patent Application Publication Nos. 2004/0186199 and 2003/0119938.

Polymers can be present in the ink jet or flexographic inks of the invention. The polymers can act as binders or jetting-aids. These polymers can be classified as water-soluble polymers, water-reducible polymers or water-dispersible polymeric particles. These polymers can be classified as organic-soluble polymers, organic-reducible polymers or organic-dispersible polymers.

By the term “water-soluble” is meant that the polymer is dissolved in water such that scattering is not observed when a dilute solution of the polymer is analyzed using dynamic light scattering or any other technique well known in the art of particle analysis.

By the term “water-reducible” is meant that the polymer can be diluted with water to form reasonably stable dispersions of polymer aggregates swollen by solvent and water, as described in “Organic Coatings: Science and Technology” (2nd Edition by Wicks, Jones and Papas, published by Wiley-Interscience, 1999). Such polymers have hydrophilic groups in some monomers, but are not water soluble until neutralized by base.

By the term “water-dispersible” is meant that the polymer exists in the form of discrete particles in water, the particles being dispersed or suspended and often stabilized against flocculation and settling by the use of dispersing agents. In contrast to a water-soluble polymer, a dilute solution of a water-dispersible polymer exhibits scattering when analyzed using dynamic light scattering or any other technique well known in the art of particle analysis.

The water soluble polymers useful in the ink compositions include nonionic, anionic, amphoteric and cationic polymers. Representative examples of water soluble polymers include polyvinyl alcohols, polyvinyl acetates, polyvinyl pyrrolidones, carboxymethyl cellulose, polyethyloxazolines, polyamides and alkali soluble resins, polyurethanes (such as disclosed in U.S. Pat. No. 6,268,101 which is incorporated by reference herein), polyacrylic acids, styrene-acrylic methacrylic acid copolymers (such as Joncryl® 70 from S.C. Johnson Co., TruDot® IJ-4655 from MeadWestvaco Corp., and Vancryl® 68S from Air Products and Chemicals, Inc and polymers exemplified in U.S. Pat. No. 6,866,379 and U.S. Patent Application Publication No. 2005/0134665 A1.

The water-dispersible polymer particles are generally classified as either addition polymers or condensation polymers, both of which are well known to those skilled in the art of polymer chemistry. Examples of water-dispersible polymer particle classes include acrylics, styrenics, polyethylenes, polypropylenes, polyesters, polyamides, polyurethanes, polyureas, polyethers, polycarbonates, polyacid anhydrides, or copolymers or combinations thereof. Such polymer particles can be ionomeric; film forming, non-film-forming, fusible, or heavily cross-linked and can have a wide range of molecular weights and glass transition temperatures.

Examples of water dispersible polymeric particles used in ink jet inks are styrene-acrylic copolymers sold under the trade names Joncryl® (S.C. Johnson Co.), Ucar™ (Dow Chemical Co.), Jonrez® (MeadWestvaco Corp.), and Vancryl® (Air Products and Chemicals, Inc.); sulfonated polyesters sold under the trade name Eastman AQ® (Eastman Chemical Co.); polyethylene or polypropylene resin emulsions and polyurethanes (such as the Witcobonds® from Witco Corp.). Core-shell polymer particles have also been employed ink jet inks for water-fastness and rub-resistance improvements (U.S. Pat. Nos. 5,814,685; 5,912,280; 6,057,384; 6,271,285; 6,858,301). Additional examples of water dispersible polymer particles include the thermoplastic resin particles as disclosed in U.S. Pat. Nos. 6,147,139 and 6,508,548. The polymer particles can be a mixture of high and low glass transition temperature polymers such as those disclosed in U.S. Pat. No. 6,498,202. Additionally, core-shell polymer particles as described in U.S. Pat. Nos. 5,814,685; 5,912,280; 6,057,384; 6,271,285, and 6,858,301 can be employed. It is also possible to include in the ink, in addition to the durability enhancing polymer particles, heavily cross-linked polymer particles.

By the term “organic-soluble” is meant that the polymer is dissolved in organic solvent such that scattering is not observed when a dilute solution of the polymer is analyzed using dynamic light scattering or any other technique well known in the art of particle analysis. Examples of organic-soluble polymers include, but are not limited to, cellulose esters, such as nitrocellulose, cellulose acetate butyrate, cellulose acetate proprionate, and cellulose acetate, acrylic resins, such as polyacrylates and polymethacrylates, polyurethanes, and polyamides. Organic-dispersible polymers, in emulsion or dispersion, can be added to improve the drying, gloss, adhesion and water resistance of inks.

Ink compositions useful in the invention include one or more water-soluble humectants, also called co-solvents, in order to provide useful properties to the ink jet ink. Typical useful properties include but are not limited to: preventing the ink composition from drying out or crusting in the nozzles of the printhead, aiding solubility of the components in the ink composition, aiding firing properties of the ink form an ejector, facilitating penetration of the ink composition into the image-recording element after printing, aiding gloss, suppressing intercolor bleed, suppressing coalescence, and suppressing mechanical artifacts such as paper cockle and curl during and after printing. Any water-soluble humectant known in the ink jet art can be employed. By water-soluble is meant that a mixture of the employed humectant(s) and water is homogeneous. While an individual humectant can be employed, useful ink jet or flexographic inks can employ mixtures of two, three or more humectants, each of which imparts a useful property to the ink jet or flexographic ink. Representative examples of humectants and co-solvents used in aqueous-based ink compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, or tetrahydrofurfuryl alcohol; (2) polyhydric alcohols, such as diols, ethylene glycol, diethylene glycol, triethylene glycol, tetraethylene glycol, propylene glycol, dipropyleneglycol, the polyethylene glycols, the polypropylene glycols, 1,2-propanediol, 1,3-propanediol, 1,2-butanediol, 1,3-butanediol, 1,4-butanediol, 1,2,4-butanetriol, 3-methyl-1,3-butanediol, 2-methyl-1,3-propanediol, 1,5-pentanediol, 1,6-hexanediol, 2-methyl-2,4-pentanediol, 1,7-hepanediol, 2-ethyl-1,3-hexane diol, 2,2,4-trimethyl-1,3-pentane diol, 1,8-octane diol, glycerol, 1,2,6-hexanetriol, 2-ethyl-2-hydroxymethyl-propanediol, 2-methyl-2-hydroxymethyl-propanediol, saccharides or sugar alcohols or thioglycol; (3) polyols such as polyoxygenated polyols or their derivatives such as diglycerol, polyglycerols, glycerol ethoxides, glycerol propoxides, glyceryths, alkylated or acetylated glyceryths, pentaerythritol, pentaerythritol ethoxides, or pentaerythritol propoxides or their alkylated or acetylated derivatives; (4) nitrogen-containing compounds such as urea, 2-pyrrolidone, N-methyl-2-pyrrolidone, imidazolidinone, N-hydroxyethyl acetamide, N-hydroxyethyl 2-pyrrolidinone, 1-(hydroxyethyl)-1,3-imidazolidinone or 1,3-dimethyl-2-imidazolidinone; or (5) sulfur-containing compounds such as 2,2′-thiodiethanol, dimethyl sulfoxide or tetramethylene sulfone or combinations thereof. Of these, glycerol and the polyhydric alcohol derivatives thereof are preferred and glycerol is especially preferred. The polyhydric alcohol derivatives of glycerol include the glycerol ethoxides, glycerol propoxides and glyceryths. The humectant can be employed alone or in combination with one or more additional listed humectants. When glycerol and the polyhydric alcohol derivatives thereof are employed, they can be employed at between 1 and 20% by weigh, preferable at between 2 and 15% by weight and more preferable at between 3 and 10% by weight. While any quantity of water soluble humectants singly or in combination can be employed, the total quantity of water soluble humectant is typically at between 3 and 45 percent by weight and preferably at between 8 and 35 percent by weight. Typical aqueous-based ink compositions useful in the invention can contain, for example, the following components based on the total weight of the ink: water 50-95%, and humectant(s) 3-45%.

Flexographic ink compositions useful in the invention can include one or more organic solvents. Representative examples include (1) alcohols such as ethanol, isopropyl alcohol, n-butanol, 1-methoxy-2-propanol, 2-(2-butoxy-isopropoxy)-2propanol; (2) acetates such as n-propyl acetate, or combinations thereof.

The pH of the aqueous ink compositions of the invention can be adjusted by the addition of organic or inorganic acids or bases. Useful inks can have a preferred pH of from about 2 to 10, depending upon the type of dye or pigment being used and depending on the charge characteristics of the other ink components employed. Anionic charge stabilized anti-abrasion polymers are employed in inks having a pH of above about 6, with preferred pH ranges of between 7 and 11 and a more preferred pH range of between 7.5 and 10. Typical inorganic acids include nitric, hydrochloric, phosphoric and sulfuric acids. Typical organic acids include methanesulfonic, acetic, formic and lactic acids. Typical inorganic bases include alkali metal hydroxides and carbonates including but not limited to sodium hydroxide and potassium hydroxide.

Ink jet or flexographic ink compositions can also contain non-colored particles such as inorganic particles or polymeric particles. The use of such particulate addenda has increased over the past several years, especially in ink compositions intended for photographic-quality imaging. For example, U.S. Pat. No. 5,925,178 describes the use of inorganic particles in pigment-based inks in order to improve optical density and rub resistance of the pigment particles on the image-recording element. In another example, U.S. Pat. No. 6,508,548 B2 describes the use of a water-dispersible polymer in dye-based inks in order to improve light and ozone resistance of the printed images. For use of such particles to improve gloss differential, light or ozone resistance, water fastness, rub resistance and various other properties of a printed image; see for example, U.S. Pat. No. 6,598,967 B1. Colorless ink compositions that contain non-colored particles and no colorant can also be used. Colorless ink compositions are often used in the art as “fixers” or insolubilizing fluids that are printed under, over, or with colored ink compositions in order to reduce bleed between colors and water fastness on plain paper; see for example, U.S. Pat. No. 5,866,638 or U.S. Pat. No. 6,450,632 B1. Colorless inks are also used to provide an overcoat to a printed image, usually in order to improve scratch resistance and water fastness; see for example, U.S. Patent Application Publication 2003/0009547 A1 or E.P. 1,022,151 A1. Colorless inks are also used to reduce gloss differential in a printed image; see for example, U.S. Pat. No. 6,604,819 B2; U.S. Patent Application Publication Nos. 2003/0085974 A1; 2003/0193553 A1; or 2003/0189626 A1.

Examples of inorganic particles useful in the invention include, but are not limited to, alumina, boehmite, clay, calcium carbonate, titanium dioxide, calcined clay, aluminosilicates, silica, or barium sulfate.

Surfactants can be added to adjust the surface tension of the ink to an appropriate level. The surfactants can be anionic, cationic, amphoteric or nonionic or combinations thereof. Surfactants can be used at levels of 0.01 to 5% of the ink composition. Examples of suitable nonionic surfactants include, linear or secondary alcohol ethoxylates (such as the Tergitol® 15-S and Tergitol® TMN series available from Union Carbide and the Brij® series from Uniquema), ethoxylated alkyl phenols (such as the Triton® series from Union Carbide), fluoro surfactants (such as the Zonyls® from DuPont; and the Fluorads® from 3M), fatty acid ethoxylates, fatty amide ethoxylates, ethoxylated and propoxylated block copolymers (such as the Pluronic® and Tetronic® series from BASF, ethoxylated and propoxylated silicone based surfactants (such as the Silwet® series from CK Witco), alkyl polyglycosides (such as the Glucopons® from Cognis) and acetylenic polyethylene oxide surfactants (such as the Surfynols from Air Products). Additionally any conformationally asymmetric water-soluble polyoxygenated hydrocarbons enabling surface tension reduction can be employed as a surfactant. Dynamic surface tension reducing agents as known in the art can also be employed. Examples include the known lower mono-alkyl ethers derived from the polyhydric alcohols; specific examples include but are not limited to ethylene glycol monomethyl ether, ethylene glycol monobutyl ether, ethylene glycol monoethyl ether acetate, diethylene glycol monomethyl ether, diethylene glycol monobutyl ether, polyethylene glycol monobutyl ether, propylene glycol monopropyl ether and diethylene glycol monobutyl ether acetate, among others all as supplied as the Dowanol®, Cellusolve® and Carbitol® series from Dow Chemical. Additional examples include the lower asymmetric alcohols; specific examples include but are not limited to: 1,2-butane diol, 1,2-hexanediol, 1-phenyl-1,2-ethanediol, 1,2-heptane diol, 1,2-octanediol, and 1,3-hexanediol.

Examples of anionic surfactants include; carboxylated (such as ether carboxylates and sulfosuccinates), sulfated (such as sodium dodecyl sulfate), sulfonated (such as dodecyl benzene sulfonate, alpha olefin sulfonates, alkyl diphenyl oxide disulfonates, fatty acid taurates and alkyl naphthalene sulfonates), phosphated (such as phosphated esters of alkyl and aryl alcohols, including the Strodex® series from Dexter Chemical), phosphonated and amine oxide surfactants and anionic fluorinated surfactants. Examples of amphoteric surfactants include; betaines, sultaines, and aminopropionates. Examples of cationic surfactants include; quaternary ammonium compounds, cationic amine oxides, ethoxylated fatty amines and imidazoline surfactants. Additional examples of the above surfactant classes are described in “McCutcheon's Emulsifiers and Detergents: 1995, North American Editor”.

It is known that a biocide can be added to an ink jet or flexographic ink composition to suppress the growth of microorganisms in the ink solution such as molds, fungi, and the like in aqueous inks. A preferred biocide for an ink composition is Proxel® GXL (Zeneca Specialties Co.) at a final concentration of 0.0001-0.5 wt. % or Kordek®. However these biocides are not effective as an antimicrobial agent after the ink has been printed and dried on a printed substrate. See Example 7A below. Additional additives which can optionally be present in an ink jet ink or flexographic ink composition include thickeners, conductivity enhancing agents, anti-kogation agents, drying agents, waterfast agents, dye solubilizers, chelating agents, binders, light stabilizers, viscosifiers, viscosity control agents, fixatives, surface tension modifiers, buffering agents, buffers, anti-curl agents, stabilizers, ink spread control agents, print head failure control agents, anticorrosion agents, corrosion inhibitors, or defoamers or combinations thereof.

The exact choice of ink components will depend upon the specific application and performance requirements of the ink jet printhead from which they are jetted or flexographic plate used for printing and will also depend on the specific substrate that will receive the ink. Thermal and piezoelectric printheads which can function either in drop-on-demand ink ejection mode or continuous ink ejection mode each require ink compositions with a different set of physical properties in order to achieve reliable and accurate jetting of the ink, as is well known in the art of ink jet printing. Acceptable viscosities are no greater than 20 cP, and preferably in the range of about 1.0 to 6.0 cP and more preferably in the range of 1.5 to 4 cP. Acceptable static surface tensions are no greater than 60 dynes/cm, and preferably in the range of 28 dynes/cm to 45 dynes/cm. The viscosities of flexographic and gravure inks are generally higher than those used for inkjet printing, and range from about 10 to 5,000 cps (mPa·s).

The ink jet inks are preferentially applied to a paper or suitable substrate by thermal or piezo ejection. The method of ink deposition can be by drop on demand or continuous. Preferentially, an ink jet printhead capable of achieving firing frequencies of at least 12 kHz with a near nozzle velocity of at least 10 meters/second is employed. Any of the known printhead designs in the art of ink jet printing can be used provided they can achieve these high speed firing frequencies. Preferably, the ink jet printer is equipped with a thermal ink jet printhead. Particularly preferred printhead designs are disclosed in United States Patent Application Publication 2006/0103691 and U.S. Pat. No. 7,600,856.

The flexographic inks are preferentially applied to a substrate using a flexographic printing element that can be a flexographic printing plate, a flexographic printing sleeve, or a flexographic printing cylinder in the round. Ink is applied to the flexographic printing element by direct contact with an inked anilox roller, followed by transfer of the ink to the substrate. This is performed using a flexographic printing press. Substrates to which the flexographic ink is applied include, but are not limited to, paper, paperboard stock, corrugated board, polymeric films, fabrics, and metal foils, and also including more rigid materials such as glass, glass-coated materials, flexible glass materials, and laminates of multiple materials.

The inks of the invention can be used alone or they can be used in combination. When used alone, the ink can be employed in a monochrome printer. When used in combination, the inks can be of similar color as in a monochrome printer or of distinct color as in a full color printer. When used in combination, two inks of similar color but distinct composition, such as a light ink and a dark ink can be used to form a finely graduated or continuous photo-tone image. Alternatively, distinct colored inks can be combined to form an ink jet or flexographic ink set. When inks according to the invention are used in combination, they are preferably applied in an overlapping mode to a common area of the paper or in non-overlapping mode to adjacent areas of the paper, all as know in the ink jet or flexographic ink application art. A color ink set preferably has at least cyan, magenta, and yellow colored inks with optimal additions of black ink(s), such as Photo-black inks and text black inks, clear inks to act as gloss aids and protective overcoats and optional red, green, blue, brown, orange, violet, photo-cyan and photo-magenta inks, and so forth to aid in pictorial reproduction, all as known in the ink jet art. A color ink set can contain both distinct colored inks and similarly colored inks of distinct composition. The ink jet ink or flexographic ink set according to the invention can include the inventive ink alone or in several inks of the ink jet ink set.

The ink jet inks, flexographic inks, ink jet ink-sets, flexographic ink sets and image forming methods described above can be usefully employed with any suitable ink jet or flexographic image receiver known in the art. This includes, but is not limited to both matte and glossy forms of plain papers, cardstocks, cardboards, transparent or opaque plastics and vinyls, treated papers, coated papers and multilayer image receivers. The glossy receivers are especially preferred as imaging media for use with the inventive ink jet inks, flexographic inks, ink jet ink-sets, flexographic ink sets and ink jet image forming methods.

The ink jet inks of the invention can be packaged in an art known ink jet ink container suitable for supplying ink to an ink ejector. The container can have one or more ink reservoirs each holding a distinct inventive ink. In one embodiment, intended for desktop applications, the reservoirs can individually hold up to about 20 ml of ink. In embodiments intended for commercial applications, the reservoirs can individually hold up to about 5 liters of ink.

The flexographic inks of the invention can be packaged in an art known, such as, for example in a container that is inert to corrosion from the ink components. UV inks are typically packaged in a light blocking container.

In the present invention, ink jet or flexographic ink can contain a silver salt. Silver sulfate, Ag₂SO₄, is a preferred silver salt. Silver sulfate is defined as an antimicrobial agent, an antibacterial agent, an antifungal agent, or biocide. Silver salts that are defined as an antimicrobial agent, an antibacterial agent, an antifungal agent, or biocide further include silver nitrate, silver chloride, silver bromide, silver iodide silver iodate, silver bromate, silver tungstate, silver hydroxide, silver fluoride, or silver phosphate. The concentration of silver salt is defined as the ratio of total mass of silver salt to total mass of ink jet or flexographic ink multiplied by 100 to give a weight % of additive. Silver sulfate used in this invention can be prepared by a number of methods as disclosed in U.S. Pat. No. 7,261,867, U.S. Pat. No. 7,655,212, U.S. Pat. No. 7,931,880, and U.S. Pat. No. 8,062,615. Included in these methods is silver sulfate prepared in aqueous solution by adding together a soluble silver salt and a soluble inorganic sulfate together under turbulent mixing conditions in a precipitation reactor. An additional method to prepare silver sulfate includes precipitation in nonaqueous solutions. Still further methods to prepare silver sulfate include solid state reaction, thermal processing, sputtering, and electrochemical processing. Additives can be included during the preparation process including size control agents, color control agents, antioxidants, and the like. Silver sulfate in this invention can be used as made or milled or ground to a smaller particle size. Determination of silver sulfate particle size is carried out using grain size measurements provided for by instance an LA-920 analyzer from Horiba Instruments, Inc. The preferred silver sulfate particle size is in a range of greater than zero but less than 20 microns, the more preferred silver sulfate particle size is in a range of greater than zero but less than 10 microns, and the most preferred silver sulfate particle size is in a range of greater than zero but less than 5 microns.

In the present invention of antimicrobial ink jet or flexographic inks, the silver sulfate is added as one of several ingredients as noted above. The silver sulfate in the ink jet or flexographic ink has a preferred concentration of 0.0005 to 0.5 weight % silver sulfate, more preferred 0.0007 to 0.4 weight % silver sulfate, most preferred 0.001 to 0.3 weight % silver sulfate.

Silver sulfate concentration in ink jet or flexographic ink is analyzed using Inductively Coupled Plasma (ICP). ICP measurements were carried out using a Perkin Elmer Optima 2000 ICP optical emission spectrometer.

Ink jet or flexographic inks of the present invention are used to make images on a support. The ink jet or flexographic ink is affixed to a support also called a substrate, also called a page, using an ink jet or flexographic printer, available in commercial and noncommercial settings. The substrate can be inorganic, organic, paper, polymer, metal or a combination thereof. The support for the ink jet or flexographic recording element used in the invention can be any of those usually used for ink jet or flexography receivers, such as paper, resin-coated paper, plastics such as a polyester-type resin such as poly(ethylene terephthalate), polycarbonate resins, polysulfone resins, methacrylic resins, cellophane, acetate plastics, cellulose diacetate, cellulose triacetate, vinyl chloride resins, poly(ethylene naphthalate), polyester diacetate, various glass materials, and microporous materials such as microvoided polyester, polyethylene polymer-containing material sold by PPG Industries, Inc., Pittsburgh, Pa. under the trade name of Teslin®, Tyvek® synthetic paper (DuPont Corp.), and OPPalyte® films (Mobil Chemical Co.) and other composite films listed in U.S. Pat. No. 5,244,861. The support can contain an ink jet or flexography receiving layer. The ink jet or flexography receiving layer can be porous or nonporous. An ink jet or flexography receiving layer that is porous includes inorganic particles such as silica, alumina, titanium dioxide, clay, calcium carbonate, barium sulfate, or zinc oxide. In another preferred embodiment, the porous ink-receiving layer includes polymeric binder, such as gelatin, poly(vinyl alcohol), poly(vinyl pyrrolidinone) or poly(vinyl acetate). The porous ink-receiving layer can also contain organic beads or polymeric micro-porous structures without inorganic filler particles as shown in U.S. Pat. Nos. 5,374,475 and 4,954,395. Examples of binders which can be used in the image-receiving layer include polyvinyl alcohol, polyvinyl pyrrolidone, poly(ethyl oxazoline), non-deionized or deionized Type IV bone gelatin, acid processed ossein gelatin or pig skin gelatin.

The deposition by an ink jet or flexographic printer can be colorless and clear or transparent defined as an ink jet or flexography coating. The minimum components in an ink jet or flexography coating are water or organic solvent, and silver salt. The silver salt can be silver sulfate. The transparent ink jet or flexography coating is typically added to an image and substrate to provide protection to the image and substrate. Transparent coating is printed in one of two ways, a constant amount and constant mass of ink jet or flexography coating over the entire image or substrate, or a varying amount or varying mass on a substrate as a function of the image content. An ink jet or flexography coating can have additional components described above.

The image can be colored defined as a colored ink jet or flexography image. The minimum components in a colored ink jet or flexography image are colorant, water or organic solvent, and silver salt. The silver salt can be silver sulfate. A colored ink jet or flexography image can have additional components described above. A colored ink jet or flexography image can be in the form of text, as letters, numbers, symbols, or as a picture or solid image with one or more colored inks deposited over a portion of a substrate or the entire substrate. The image can include a transparent ink jet or flexography coating only, colored ink jet or flexography image only, or a combination of transparent ink jet or flexography coating and colored image. The amount of silver sulfate deposited in a transparent ink jet or flexography coating is measured by ICP as micrograms silver per total sample weight. The amount of silver sulfate deposited in a colored ink jet or flexography image is measured as coverage by ICP as micrograms silver per total sample weight.

The following is a simple description of how a drop on demand ink jet coating or ink jet image is produced:

1) A digital file is sent to the ink jet printer by computer, scanner, copier or similar method.

2) The ink jet printer control circuitry activates the paper feed stepper motor. This engages the rollers, which feed a sheet of paper, also called the page, from the paper tray/feeder into the printer.

3) Once the paper is fed into the printer and positioned at the start of the page, the print head stepper motor uses a belt to move the print head assembly across the page, and print head sprays dots of ink on the page creating the ink jet coating or ink jet image.

4) At the end of each complete pass, the paper feed stepper motor advances the paper a fraction of an inch. Depending on the ink jet model, the print head is reset to the beginning side of the page, or, in most cases, simply reverses direction and begins to move back across the page as it prints.

5) This process continues until the page is printed. The time it takes to print a page can vary widely from printer to printer. It will also vary based on the complexity of the page and size of any images on the page.

6) Once the printing is complete the print head is parked. The paper feed stepper motor spins the rollers to finish pushing the completed page into the output tray. Most printers today use inks that are very fast-drying, so that you can immediately pick up the sheet without smudging it.

The following is a simple description of how a flexography coating or flexography image is printed:

1) An imaged flexographic printing plate is mounted using a backing tape to a printform cylinder in a flexographic printing apparatus.

2) A digital file is sent to the flexographic printing apparatus by computer, scanner, copier or similar method.

3) The flexographic printing apparatus control circuitry activates the receiver substrate feed supply, which can be in sheet fed form or continuous roll-to-roll form.

4) The flexographic printing apparatus control circuitry also activates the series of inking, anilox, and printform controllers.

5) In a sequential and continual series of steps, the anilox roller comes in contact with the flexographic ink and excess ink is skived from the anilox roller with a doctor blade, the anilox roller then comes into contact with the imaged flexographic printing plate, transferring a portion of the ink from the anilox to the plate, then the plate comes in contact with the receiver substrate where a portion of the ink is transferred from the plate to the receiver substrate.

6) This process is continues and performed at a specified printing speed. Several stations as described in step (5) can be placed sequentially to print multiple colors or inks.

7) Once the printing is complete the press is stopped. Most printers today use inks that are very fast-drying, so that you can immediately pick up the sheet or roll up the receiver without smudging it.

Fixing an ink jet or flexography image generally includes drying. Drying can occur by permitting the printed page to dry in the ambient air surrounding the printer. Drying can also occur using a forced air drying method such as air directed toward a printed page using a fan, blower or similar apparatus. The forced air can be below room temperature, at room temperature, or above room temperature. A drying oven can be used to dry a printed page. Additional ambient and nonambient methods can be used for drying a printed page.

The silver sulfate in the present invention is present in a transparent ink jet or flexography overcoat or a colored ink jet or flexography image, on a substrate providing antibacterial and antifungal protection. Antimicrobial efficacy is tested by utilizing standard biological methods referred to as challenge tests whereby an image printed on paper using toner of the present invention is exposed to a particular microbe under controlled conditions. Samples were evaluated for antimicrobial activity using a modified version of the American Society for Testing and Materials methods ASTM E-2180 “Standard Test Method for Determining the Activity of Incorporated Antimicrobial Agent (s) in Polymeric or Hydrophobic Materials”. In these tests, substrates with printed images including ink of the present invention were inoculated with challenge organisms of bacteria (Klebsiella pneumonia) or fungi (Aspergillus Brasiliensis, previously referred to as Aspergillus Niger). The time and exposure conditions (temperature, relative humidity, for example) are controlled to promote growth of the organism and controls are run in parallel to establish colony viability and to establish blank substrates are compatible with the organisms (i.e. that they don't have antimicrobial effects without the test agent). In some procedures nutrients are added to further promote growth. Qualitative methods involve visual observations of zones of inhibition (no presence of organisms in direct contact with or in the vicinity of the sample). Quantitative methods measure reduction in colonies over the course of the test period. A reduction of greater than 30% demonstrates efficacy against the challenge organism.

Transparent ink jet or flexography coatings contain silver sulfate antimicrobial biocide are assessed for visual discoloration when exposed to fluorescent light. Silver sulfate containing transparent ink jet or flexography coatings exposed to fluorescent light are compared to silver sulfate containing transparent ink jet or flexography coatings kept dark. A transparent ink jet or flexography coating that shows no observable discoloration demonstrates color stability.

Ink jet coatings, flexography coatings, color ink jet images or color ink jet images with an ink jet coating, flexography images with a flexography coating are assessed for color stability via colorimetric. The CIE (Commission Internationale De L'Eclairage or International Commission on Illumination) has created a colorimetric measurement transform, called L* a* b*, or otherwise referred to as CIE Lab. L=lightness (0=total dark black, 100=brightest white) and a and b define color hue+b=yellow, −b=blue, +a=red, −a=green. All colors fall within this grid, and by mapping out all possible colors that a printing device can produce, the printer gamut is defined. A measure of color stability is ΔE*₀₀ known as CIEDE2000. Colorimetric measurement of L*, a* and b* for a check sample or a feature sample permits for calculation of ΔE*₀₀. The check is a print with dry clear ink ink jet coating containing no Ag₂SO₄ whereas, the feature is a print with dry clear ink clear ink jet coating containing an aim of 500 micrograms/gram Ag₂SO₄ in the ink solution. One half of an ink jet or flexography coating on support was covered with light blocking black paper, the other half of the ink jet or flexography coating on support was uncovered, followed by simultaneous exposure to unfiltered ambient room fluorescent light and silica glass filtered outdoor ambient light for 7 days. Colorimetric measurements were made immediately after the ink jet coating was generated and after the 7 days light exposure. A value of ΔE*₀₀ less than 1 demonstrates color stability.

The silver sulfate in the present invention is present in a transparent ink jet ink or a colored ink jet ink and is evaluated for ability to be jetted by an ink jet printer. The silver sulfate in the present invention is present in a transparent flexographic ink or a colored flexographic ink and is evaluated for ability to be deposited by a flexographic printer. In one evaluation an acceptable ink containing a silver salt including silver sulfate will maintain an acceptable viscosity after the silver salt has been added to the ink jet ink. In another evaluation, the ink jet ink with silver salt, including silver sulfate, is loaded in an ink jet cartridge and the ink is projected onto a support to form a transparent ink jet coating or an ink jet image. In another evaluation, the flexographic ink with silver salt, including silver sulfate, is loaded in an ink canister or container and the ink is transferred onto a support to form a transparent flexography coating or a flexography image. A transparent ink jet or flexography coating or an ink jet or flexography image with no observable defects demonstrates successful jetting or deposition of the ink.

### EXAMPLES

Examples of the present invention were evaluated based on ability to be successfully formulated to maintain an acceptable viscosity, color stability, printability using an ink jet or flexographic printer, or efficacy or any combination of these four criteria.

Silver sulfate antimicrobial, water, organic solvent, water insoluble pigment, pigment dispersant, water soluble dye, dye solubility agent, ink spread control agent, jetting aid, print head failure control agent, humectants, water dispersible or water miscible polymer, solvent soluble or solvent dispersible polymer, viscosifier, surfactant, anticorrosion agent, organic biocide, dye or pigment light or oxidation stabilizer, crosslinkable monomer, photoinitiator, or buffer or any combination thereof were used in the examples of this invention.

### Inventive Example 1

Ink samples for drop on demand printing applications were generated in ambient air and ambient room fluorescent light. Into a plastic vessel was charged and mixed designated amounts of water, organic solvent, print head failure control agent, humectants, water dispersible or water miscible polymer, viscosifier, surfactant, anticorrosion agent, organic biocide, buffer, and Ag₂SO₄. In addition, colored inks contained pigment, pigment dispersant, and jetting aid. Ag₂SO₄ levels in the ink dispersions were determined by ICP. Inks were evaluated for color and viscosity.

| | | Acceptable | Acceptable | Ag₂SO₄ level |
|---|---|---|---|---|
| Sample | Color | Color | Viscosity | (micrograms/gram) |
| Ex1A | Clear | Yes | Yes | 500 |
| Ex1B | PhotoBlack | Yes | Yes | 430 |
| Ex1C | TextBlack | Yes | Yes | 480 |
| Ex1D | Yellow | Yes | Yes | 500 |
| Ex1E | Cyan | Yes | Yes | 460 |
| Ex1F | Magenta | Yes | Yes | 460 |
| Ex1G | Clear | Yes | Yes | 75 |
| Ex1H | PhotoBlack | Yes | Yes | 65 |
| Ex1I | TextBlack | Yes | Yes | 46 |
| Ex1J | Yellow | Yes | Yes | 82 |
| Ex1K | Cyan | Yes | Yes | 98 |
| Ex1L | Magenta | Yes | Yes | 71 |

The inks of Example 1 all showed acceptable color and viscosity, indicating these inks could be used in an ink jet printer to produce ink jet coatings in the case of Ex1A and Ex1G, and ink jet images in the case of Ex1B-F and Ex1H-L.

### Inventive Example 2

Ink jet coatings and ink jet images were produced with Example 1 ink jet inks using a Kodak ESP5AiO printer. The support was Kodak Ink jet Photo paper. The printability of all Example 1 inks was found to be acceptable.

An ink jet coating was deposited on multiple ink jet images. Analysis by ICP for an aliquot from an ink jet coating on ink jet images comprised of a picture or a picture and text determined the Ag₂SO₄ coverage was:

| | ICP Ag₂SO₄ |
|---|---|
| Sample | micrograms/gram |
| ink jet coating on an ink jet image comprised of a | 19 |
| picture | |
| ink jet coating on an ink jet image comprised of a | 22 |
| picture and text | |

An aliquot from each Example 2 ink jet image was tested for antimicrobial efficacy using ASTM E-2180.
Klebsiella pneumonia:

| | | | | | Percent Reduction |
|---|---|---|---|---|---|
| | | | | | from ink jet |
| | Counts | | | Average | control (control |
| Sample | (triplicate) | | | CFU/ml | has no Ag₂SO₄) |
| Ink jet control uncoated | 64 | 68 | 139 | 3.6E+05 | — |
| support (no Ag₂SO₄) | | | | | |
| ink jet coating on an ink | 0 | 0 | 0 | 393 | 99.9 |
| jet image comprised of a | | | | | |
| picture | | | | | |
| ink jet coating on an ink | 0 | 0 | 0 | <40 | 100 |
| jet image comprised of a | | | | | |
| picture and text | | | | | |

### Aspergillus Brasiliensis:

| | | | | | Percent |
|---|---|---|---|---|---|
| | | | | | Reduction |
| | | | | | from ink jet |
| | | | | | control |
| | | | | Average | (control has |
| Sample | Counts (triplicate) | | | CFU/ml | no Ag₂SO₄) |
| Ink jet control uncoated | 30 | 0 | 8 | 5.0E+2 | — |
| support (no Ag₂SO₄) | | | | | |
| ink jet coating on an ink | 0 | 0 | 0 | <40 | 92.1 |
| jet image comprised of a | | | | | |
| picture | | | | | |
| ink jet coating on an ink | 0 | 0 | 0 | <40 | 92.1 |
| jet image comprised of a | | | | | |
| picture and text | | | | | |

The results in Example 2 indicate antimicrobial efficacy against bacteria and fungi.

### Inventive Example 3

Ink samples for drop on demand printing applications were generated in ambient air and ambient room fluorescent light. Into a plastic vessel was charged and mixed designated amounts of water, organic solvent, humectants, polymer, viscosifier, surfactant, organic biocide, buffer, and Ag₂SO₄. In addition, colored inks contained dye and dye solubility agent. In addition clear ink contained water dispersible or water miscible polymer. Ag₂SO₄ levels in the ink dispersions were determined by ICP Inks were evaluated for color and viscosity.

| | | Acceptable | Acceptable | Ag₂SO₄ level |
|---|---|---|---|---|
| Sample | Color | Color | Viscosity | (micrograms/gram) |
| Ex3A | Clear | Yes | Yes | 78 |
| Ex3B | PhotoBlack | Yes | Yes | 90 |
| Ex3C | PhotoCyan | Yes | Yes | 40 |
| Ex3D | Photo- | Yes | Yes | 64 |
| | Magenta | | | |
| Ex3E | Black | Yes | Yes | 65 |
| Ex3F | Yellow | Yes | Yes | 45 |
| Ex3G | Cyan | Yes | Yes | 78 |
| Ex3H | Magenta | Yes | Yes | 42 |

The inks of Example 3 all showed acceptable color and viscosity, indicating these inks could be used in an ink jet printer to produce ink jet coatings in the case of Ex3A, and ink jet images in the case of Ex3B-H.

### Inventive Example 4

Ink jet coatings and ink jet images were produced with Example 3 ink jet inks using a Kodak ESP5AiO printer. The support was Kodak Ink jet Photo paper. The printability of all Example 3 inks was found to be acceptable.

An ink jet coating was deposited on multiple ink jet images. Analysis by ICP for an aliquot from an ink jet coating on an ink jet image comprised of a picture determined the Ag₂SO₄ coverage was:

| | ICP Ag₂SO₄ |
|---|---|
| Sample | micrograms/gram |
| ink jet coating on an ink jet image | 6.9 |
| comprised of a picture #1 | |
| ink jet coating on an ink jet image | 1.6 |
| comprised of a picture #2 | |
| ink jet coating on an ink jet image | 2.2 |
| comprised of a picture #3 | |

An aliquot from Example 4 picture 1 was tested for antimicrobial efficacy using ASTM E-2180.

### Aspergillus Brasiliensis:

| | | | | | Percent |
|---|---|---|---|---|---|
| | | | | | Reduction |
| | | | | | from ink jet |
| | | | | | control |
| | | | | Average | (control has |
| Sample | Counts (triplicate) | | | CFU/ml | no Ag₂SO₄) |
| Ink jet control (no | 6 | 3 | 8 | 1.9E+05 | — |
| Ag₂SO₄) | 2 | 3 | 7 | | |
| ink jet coating on an ink | 3 | 1 | 2 | 8.0E+04 | 57.9 |
| jet image comprised of a | 6 | 0 | 0 | | |
| picture #1 | | | | | |

The results in Example 4 indicate antimicrobial efficacy against fungi.

### Inventive Example 5

Ink sample for continuous printing applications was generated in ambient air and ambient room fluorescent light. Into a plastic vessel was charged and mixed designated amounts of water, surfactant, humectant, polymer, defoamer, anticorrosion agent, cyan pigment, pigment dispersant and Ag₂SO₄. Ag₂SO₄ level in the ink dispersions was determined by ICP. Inks were evaluated for color and viscosity.

| | | Acceptable | Acceptable | Ag₂SO₄ level |
|---|---|---|---|---|
| Sample | Color | Color | Viscosity | (micrograms/gram) |
| Ex5A | Cyan | Yes | Yes | 130 |

The ink of Example 5 showed acceptable color and viscosity, indicating this ink could be used in an ink jet printer to produce ink jet images in the case of Ex5A.

### Inventive Example 6

Ink jet images were produced with Example 5 ink using a patch coater using a Kodak Prosper Printer printhead. The support was Kodak Ink jet Photo paper. The printability of Example 5 ink was found to be acceptable.

An ink jet image was generated. Analysis by ICP for an aliquot from an ink jet image comprised of a solid cyan picture determined the Ag₂SO₄ coverage was:

| | ICP Ag₂SO₄ |
|---|---|
| Sample | micrograms/gram |
| ink jet image comprised of a solid cyan picture | 130 |

An aliquot from Example 6 was tested for antimicrobial efficacy using ASTM E-2180.

### Aspergillus Brasiliensis:

| | | | | | Percent |
|---|---|---|---|---|---|
| | | | | | Reduction |
| | | | | | from ink jet |
| | | | | | control |
| | | | | Average | (control has |
| Sample | Counts (triplicate) | | | CFU/ml | no Ag₂SO₄) |
| Ink jet control (no | 6 | 3 | 8 | 1.93E+05 | — |
| Ag₂SO₄) | 2 | 3 | 7 | | |
| ink jet coating of a solid | 2 | 2 | 3 | 1.27E+05 | 33.2 |
| cyan patch | 3 | 3 | 6 | | |

The results in Example 6 indicate antimicrobial efficacy against fungi.

### Inventive Example 7

Ink samples for drop on demand printing applications were generated in ambient air and ambient room fluorescent light. Into a plastic vessel was charged and mixed designated amounts of water, organic solvent, print head failure control agent, humectants, water dispersible or water miscible polymer, viscosifier, surfactant, anticorrosion agent, organic biocide, buffer, jetting aid, carbon black pigment, pigment dispersant and Ag₂SO₄. Aim Ag₂SO₄ levels in the ink dispersions are presented in the table below.

| | | | | Aim Ag₂SO₄ |
|---|---|---|---|---|
| | | Acceptable | Acceptable | level |
| Sample | Color | Color | Viscosity | (micrograms/gram) |
| Ex7A | TextBlack | Yes | Yes | 0 |
| Ex7B | TextBlack | Yes | Yes | 500 |
| Ex7C | TextBlack | Yes | Yes | 2500 |
| Ex7D | TextBlack | Yes | Yes | 5000 |

The inks of Example 7 all showed acceptable color and viscosity, indicating these inks could be used in an ink jet printer to produce ink jet images.

### Inventive Example 8

Ink jet images were produced with Example 7 ink jet inks using a Kodak ESP5AiO printer. The support was Kodak Luster Ink jet Photo paper. The printability of all Example 7 inks was found to be acceptable. Prolonged exposure to unfiltered ambient room fluorescent light did not result in any observed color change.

Analysis by ICP for an aliquot from an ink jet image comprised of a solid black picture determined the Ag₂SO₄ coverage was:

| | ICP Ag₂SO₄ |
|---|---|
| Sample | micrograms/gram |
| ink jet image comprised of a solid black picture - | 0 |
| 0 micrograms/gram ink | |
| ink jet image comprised of a solid black picture - | 13 |
| 500 micrograms/gram ink | |
| ink jet image comprised of a solid black picture - | 61 |
| 2500 micrograms/gram ink | |
| ink jet image comprised of a solid black picture - | 120 |
| 5000 micrograms/gram ink | |

An aliquot from each Example 8 ink jet image prints was tested for antimicrobial efficacy using ASTM E-2180.
Klebsiella pneumonia:

| | | | | | Percent |
|---|---|---|---|---|---|
| | | | | | Reduction |
| | | | | | from ink jet |
| | | | | | control |
| | | | | Average | (control has |
| Sample | Counts (triplicate) | | | CFU/ml | no Ag₂SO₄) |
| ink jet image comprised | 215 | 145 | 182 | 7.3E+06 | — |
| of a solid black picture -0 | 187 | 166 | 201 | | |
| micrograms/gram ink | | | | | |
| Control | | | | | |
| ink jet image comprised | 0 | 0 | 0 | 0.0E+00 | 100 |
| of a solid black picture - | 0 | 0 | 0 | | |
| 500 | | | | | |
| micrograms/gram ink | | | | | |
| ink jet image comprised | 0 | 0 | 0 | 0.0E+00 | 100 |
| of a solid black picture - | 0 | 0 | 0 | | |
| 2500 | | | | | |
| micrograms/gram ink | | | | | |
| ink jet image comprised | 0 | 0 | 0 | 0.0E+00 | 100 |
| of a solid black picture - | 0 | 0 | 0 | | |
| 5000 | | | | | |
| micrograms/gram ink | | | | | |

The results in Example 8 indicate antimicrobial efficacy against bacteria using samples Ex 7B-D that contain Ag₂SO₄. Sample Ex7A that contains the original wet dispersion organic biocide does not exhibit antimicrobial efficacy in the printed ink jet image.

### Comparative Example 1

An ink sample for drop on demand printing applications was generated in ambient air and ambient room fluorescent light. Into a plastic vessel was charged and mixed designated amounts of water, organic solvent, print head failure control agent, humectants, water dispersible or water miscible polymer, viscosifier, surfactant, anticorrosion agent, organic biocide, buffer, jetting aid, carbon black pigment, pigment dispersant and Ag₂SO₄. Aim Ag₂SO₄ level in the ink dispersion is presented in the table below.

| | | | | Aim Ag₂ SO₄ |
|---|---|---|---|---|
| | | Acceptable | Acceptable | level |
| Sample | Color | Color | Viscosity | (micrograms/gram) |
| CoEx1 | TextBlack | Yes | No | 10000 |

The ink of Comparative Example 1 showed acceptable color however it shows unacceptable viscosity. The ink CoEx1 became very thick and viscosity increased compared to all inks in Inventive Example 7. The result of Comparative Example 1 indicates there is a limit to the amount of silver salt that can be added to usable ink jet dispersions.

### Comparative Example 2

An attempt was made to generate ink jet images produced with Comparative Example 1 ink jet ink using a Kodak ESP5AiO printer. The support was Kodak Luster Ink jet Photo paper. The printability of Comparative Example 1 ink was unacceptable as the portions of the ink jet printer printhead became clogged resulting in an ink jet image that was nonuniform. The result of Comparative Example 2 indicates there is a limit to the amount of silver salt that can be added to usable ink jet dispersions.

### Inventive Example 9

A clear ink with no Ag₂SO₄ and a clear ink using the process of Ex1A with an aim Ag₂SO₄ level of 500 micrograms/gram were produced and used to generate ink jet coatings using a Kodak ESP5AiO printer. The support was Kodak Ultimate Paper. One half of an ink jet coating on support was covered with light blocking black paper, the other half of the ink jet coating on support was uncovered, followed by simultaneous exposure to unfiltered ambient room fluorescent light and silica glass filtered outdoor ambient light for 7 days. Colorimetric measurements were made immediately after the ink jet print was generated and after 7 days simultaneous exposure to unfiltered ambient room fluorescent light and silica glass filtered outdoor ambient light exposure. The results are in the table below.

| | 7 Day Light | | | | Delta | Delta | Delta | Delta | |
|---|---|---|---|---|---|---|---|---|---|
| | Exposure | Delta | Delta | Delta | Red | Green | Blue | Visual | |
| Sample/Ink | Condition | L* | a* | b* | Density | Density | Density | Density | ΔE*00 |
| CheckL/ | Light | 0.25 | 0.13 | 0.533 | −0.003 | −0.002 | −0.002 | 0.001 | 0.48 |
| Clear Ink | | | | | | | | | |
| Ex9 FeatureL/ | Light | 0.32 | 0.04 | 0.631 | −0.004 | −0.003 | −0.003 | 0.001 | 0.52 |
| Clear Ink with | | | | | | | | | |
| 500 micrograms/ | | | | | | | | | |
| gram Ag₂SO₄ | | | | | | | | | |
| CheckD/ | Dark | 0.08 | 0.08 | 0.206 | −0.001 | −0.002 | −0.001 | 0.001 | 0.21 |
| Clear Ink | | | | | | | | | |
| Ex9 FeatureD/ | Dark | 0.07 | −0.02 | 0.177 | −0.001 | −0.001 | −0.001 | 0.001 | 0.13 |
| Clear Ink with | | | | | | | | | |
| 500 micrograms/ | | | | | | | | | |
| gram Ag₂SO₄ | | | | | | | | | |

The ΔE*₀₀ colorimetric values observed for Example 9 ink jet coatings Ex9 FeatureL and Ex9 FeatureD were below the ΔE*₀₀ value of 1indicating ink jet coatings generated using this invention have acceptable color stability.

### Comparative Example 3

A clear ink sample for drop on demand printing applications was generated in ambient air and ambient room fluorescent light. Into a plastic vessel was charged and mixed designated amounts of water, organic solvent, print head failure control agent, humectants, water dispersible or water miscible polymer, viscosifier, surfactant, anticorrosion agent, organic biocide, and buffer.

Into a glass vessel was charged a defined amount of silver salt followed by the addition of a defined amount of the clear ink of this comparative example. The silver salt and clear ink samples were mixed for 30 seconds using a VWR vortex mixer. After mixing the samples remained in the glass vessels, and were exposed to unfiltered ambient fluorescent light for 7 days.

| | | | Observations after |
|---|---|---|---|
| | | | exposure to |
| | | Added | unfiltered ambient |
| | | micrograms/gram | fluorescent light |
| Sample | Silver Salt | silver salt | for 7 days. |
| CoEx3A Control | none | 0 | Clear and |
| Sample | | | colorless |
| CoEx3B | Ag₂SO₄ | 100 | Clear and light |
| | | | yellow |
| CoEx3C | Ag₂SO₄ | 494 | Clear and reddish |
| CoEx3D | Ag₂SO₄ | 3004 | Clear and dark red |
| CoEx3E | Ag₂SO₄ | 9951 | Solid mass and |
| | | | pale brown |
| CoEx3F | AgNO3 | 100 | Clear and light |
| | | | yellow |
| CoEx3G | AgNO3 | 498 | Clear and reddish |
| CoEx3H | AgNO3 | 2927 | Cloudy and dark |
| | | | red, solid mass on |
| | | | bottom of vessel |
| CoEx3I | AgNO3 | 9951 | Solid mass and |
| | | | pale brown |
| CoEx3J | AgI | 98 | Clear, AgI on |
| | | | bottom of vessel |
| CoEx3K | AgI | 499 | Clear, AgI on |
| | | | bottom of vessel |
| CoEx3L | AgI | 2978 | Clear, AgI on |
| | | | bottom of vessel |
| CoEx3M | AgI | 9937 | Clear, AgI on |
| | | | bottom of vessel |

Prolonged exposure to light caused samples CoEx3B-I to discolor when compared to control sample CoEx3A. Furthermore, Examples CoEx3E, CoEx3H and CoEx3I have solid masses that will render these ink compositions unusable in an ink jet printer cartridge for ink jet printing. Given these results, it is unexpected that a solution that discolors in ambient lighting would, when coated or printed, both (1) not discolor the image or substrate and (2) provide the substrate with antimicrobial efficacy. An unexpected result is ink jet coatings made with Ag₂SO₄ salt as demonstrated by this invention do not show any discoloration upon prolonged exposure to light.

Samples CoEx3J-M containing AgI did not demonstrate solubility in the ink jet ink of Comparative Example 3, as essentially all added AgI was present at the bottom of the glass vessel. This result demonstrates that it is unexpected that adding a silver salt to an ink jet ink will result in silver ion availability for antimicrobial efficacy of an ink jet coating or ink jet print.

### Inventive Example 10

An ink sample for flexographic printing applications was generated in ambient air and ambient room fluorescent light. 2.0041 grams of a commercial flexographic cyan printing ink [Aqueous Flint Ink: Process Cyan ACE Hydrofilm HMR50080-473 (lot #US-111343302500); 48.7 wt % solids content, as determined by gravimetric analysis] was added to a glass vessel. To this ink was added 0.0112 grams of Ag₂SO₄ powder and the resulting solution was mixed. Inks were evaluated for color and viscosity. The mixture remained stable, showing no flocculation, precipitation, or color change for up to at least 3 days. The viscosity showed a very slight increase but remained within optimal printing range, indicating these inks could be used in a flexographic printer to produce flexographic prints.

### Inventive Example 11

An ink sample for flexographic printing applications was generated in ambient air and ambient room fluorescent light. 2.007 grams of a commercial flexographic cyan printing ink [Solvent Cyan Flexo Ink: Thermogloss from Tapecon; Batch #116266); 33.3 wt % solids content, as determined by gravimetric analysis] was added to a glass vessel. To this ink was added 0.0109 grams of Ag₂SO₄ powder and the resulting solution was mixed. Inks were evaluated for color and viscosity. The mixture remained stable, showing no flocculation, precipitation, or color change for up to at least 3 days. The viscosity showed a very slight increase but remained within optimal printing range, indicating these inks could be used in a flexographic printer to produce flexographic prints.

### Comparative Example 4

An ink sample for flexographic printing applications was used as received from a commercial flexographic cyan printing ink [Aqueous Flint Ink: Process Cyan ACE Hydrofilm HMR50080-473 (lot #US-111343302500)]. No Ag₂SO₄ powder was added to this ink.

### Comparative Example 5

An ink sample for flexographic printing applications was used as received from a commercial flexographic cyan printing ink [Solvent Cyan Flexo Ink: Thermogloss from Tapecon; Batch #116266)]. No Ag₂SO₄ powder was added to this ink.

### Printing of Flexographic Inks:

A commercial Flexcel NX (Eastman Kodak Company) flexographic printing plate, imaged with a patterned relief image containing lines, dots, and various solid areas, was mounted to a print form cylinder of an IGT F1 printability tester from IGT Testing Systems Inc. (set up in the flexographic mode) using a 3M pink mounting tape (1920H). This flexographic printer was used to print the inks from Inventive Examples 10 and 11 and Comparative Examples 4 and 5 onto a receiver substrate that was poly(ethylene terephthalate) [PET], coated with a thin layer (0.1 micron thick) of a copolymer of acrylonitrile (N), Vinyl chloride (Vc), and acrylic acid (C), thus producing an image. The print quality was evaluated and is shown in the table below.

| | micrograms/gram | | Acceptable | |
|---|---|---|---|---|
| | Ag₂SO₄ in the | Acceptable | viscosity | Print |
| Ink sample | ink (aim) | color | and stability | quality |
| Inventive | 5560 | yes | yes | good |
| Example 10 | | | | |
| (aqueous) | | | | |
| Comparative | 0 | yes | yes | good |
| Example 4 | | | | |
| (aqueous | | | | |
| control) | | | | |
| Inventive | 5430 | yes | yes | good |
| Example | | | | |
| 11 (solvent) | | | | |
| Comparative | 0 | yes | yes | good |
| Example 5 | | | | |
| (solvent | | | | |
| control) | | | | |

Analysis by ICP for an aliquot from a flexographic image of each print determined the Ag₂SO₄ coverage was:

| | ICP Ag₂SO₄ |
|---|---|
| | micrograms/ |
| Sample | gram |
| Comparative Example 4 flexographic image comprised of | 0 |
| solid blue picture - 0 microgram Ag₂SO₄/gram ink | |
| Inventive Example 10 flexographic image comprised of | 58 |
| solid blue picture - 5560 microgram Ag₂SO₄/gram ink | |
| Comparative Example 5 flexographic image comprised of | 0 |
| solid blue picture - 0 microgram Ag₂SO₄/gram ink | |
| Inventive Example 11 flexographic image comprised of | 4 |
| solid blue picture - 5430 microgram Ag₂SO₄/gram ink | |

An aliquot from Inventive Examples 10 and 11 ink jet image prints and from Comparative Examples 4 and 5 prints were tested for antimicrobial efficacy using ASTM E-2180.
Klebsiella pneumonia:

| | | Percent |
|---|---|---|
| | | Reduction |
| | | from control |
| | Average | (control has |
| Sample | CFU/ml | no Ag₂SO₄) |
| Comparative Example 4 | 4.0E+07 | — |
| flexographic image | | |
| comprised of solid blue | | |
| picture - 0 microgram | | |
| Ag₂SO₄/gram ink | | |
| Aqueous Control | | |
| Inventive Example 10 | <2500 | 99.994 |
| flexographic image | | |
| comprised of solid blue | | |
| picture - 5560 microgram | | |
| Ag₂SO₄/gram ink | | |
| Aqueous | | |
| Comparative Example 5 | 4.0E+07 | — |
| flexographic image | | |
| comprised of solid blue | | |
| picture - 0 microgram | | |
| Ag₂SO₄/gram ink | | |
| Solvent Control | | |
| inventive Example 11 | 3.5E+06 | 91.350 |
| flexographic image | | |
| comprised of solid blue | | |
| picture - 5430 microgram | | |
| Ag₂SO₄/gram ink | | |

The invention has been described in detail with particular reference to certain preferred embodiments thereof, but it will be understood that variations and modifications can be effected within the spirit and scope of the invention.

1. An ink for use in a printer, comprising;
a solvent; and
a silver sulfate biocide having a concentration of 0.0005 to 0.5 weight %.

2. The ink according to claim 1 wherein the solvent includes water.

3. The ink according to claim 1 wherein the solvent is an organic solvent.

4. The ink according to claim 3 wherein the organic solvent includes ethanol, isopropyl alcohol, n-butanol, 1-methoxy-2-propanol, 2-(2-butoxy-isopropoxy)-2propanol, n-propyl acetate or combinations thereof.

5. The ink according to claim 1 further including a binder.

6. The ink according to claim 5 wherein the binder includes polymeric material.

7. The ink according to claim 6 wherein the binder includes polyurethane or polycarbonate, cellulose esters or combinations thereof.

8. The ink according to claim 1 further including a colorant.

9. The ink according to claim 8 wherein the colorant includes pigment.

10. The ink according to claim 9 wherein the colorant further includes, but not limited to, azo pigments, monoazo pigments, di-azo pigments, azo pigment lakes, β-Naphthol pigments, Naphthol AS pigments, benzimidazolone pigments, di-azo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, or carbon black or combinations thereof.

11. The ink according to claim 8 wherein the colorant includes dye.

12. The ink according to claim 11 wherein the colorant further includes, but not limited to water-soluble reactive dyes, direct dyes, anionic dyes, cationic dyes, acid dyes, food dyes, metal-complex dyes, phthalocyanine dyes, anthraquinone dyes, anthrapyridone dyes, azo dyes, rhodamine dyes, or solvent dyes or combinations thereof.

13. The ink according to claim 1 wherein the silver sulfate biocide concentration range is 0.0007 to 0.4 weight %.

14. The ink according to claim 1 wherein the silver sulfate biocide concentration range is 0.001 to 0.3 weight %.

15. The ink according to claim 1 further including silver nitrate, silver chloride, silver bromide, silver iodide, silver iodate, silver bromate, silver tungstate, or silver phosphate.

16. The ink according to claim 1 wherein the ink further includes a humectant.

17. The ink according to claim 16 wherein the humectant further includes alcohols, polyhydric alcohols, polyols, nitrogen-containing compounds, or sulfur-containing compounds or combinations thereof.

18. The ink according to claim 1 wherein the ink further includes a surfactant.

19. The ink according to claim 18 wherein the surfactant further includes anionic, cationic, amphoteric or nonionic surfactants or combinations thereof.

20. The ink according to claim 1 wherein the ink further includes chelating agents, buffers, viscosity control agents, stabilizers, crosslinkable monomer, photoinitiator, or corrosion inhibitors or combinations thereof.

21. A method of providing an ink image on a receiver, comprising:
(a) providing an ink comprising a solvent; and a silver sulfate biocide having a concentration of 0.0005 to 0.5 weight %; and
(b) forming an image on the receiver using the ink.
